(19) United States
(12) Patent Application Publication
(10) Pub. No.: US 2012/0204403 A1
(43) Pub. Date: Aug. 16, 2012

(54) ELEVATOR GAP BLOCKING DEVICE

(76) Inventor: Leonard Barry Spencer, Bowmaville (CA)

(21) Appl. No.: 13/372,642

(22) Filed: Feb. 14, 2012

(30) Foreign Application Priority Data
Feb. 14, 2011 (CA) 2,731,736

(51) Int. Cl. B66B 7/00; B23P 11/00

(52) U.S. Cl. 29/428; 187/400

(57) ABSTRACT

Devices and methods for blocking a gap between an elevator cab and a landing platform to prevent objects falling into the elevator shaft when the cab is adjacent the landing platform and any doors therebetween are open. A plurality of bristles is attached to the cab substantially adjacent the floor or sides of the cab and extending substantially perpendicular to the exterior of the cab to impede passage of objects through the gap. The device comprises a plurality of bristles attached to a frame and optionally secured to the frame by a bristle assembly. The device includes means for fastening to the elevator cab so that the bristles are adjacent and substantially planar to the floor or sides of the cab. The devices and methods thus provide easier retrieval of items dropped over the gap and provide a visual cue to deter disposal of detritus or debris through the gap.

### RELATED APPLICATION

This application claims the benefit under Title 35, U.S.C., S.119(e) of Canadian Application No. 2,731,736 filed on Feb. 14, 2011, which is herein incorporated by reference.

### FIELD OF THE INVENTION

The present disclosure relates to the field of structural systems for elevators. More particularly, the present disclosure relates to systems for blocking gaps between an elevator and a platform.

### BACKGROUND OF THE INVENTION

Elevators are a common means of transportation between floors of buildings. In office buildings and large apartment buildings, for example, there can be many elevators used by many passengers and cargo on a daily basis. When an elevator cab is disposed in an elevator shaft adjacent a landing platform for a floor of a building, and any doors between the elevator and the platform are opened, passengers and cargo are permitted access to the elevator through an entrance defined between the cab and the landing platform. The entrance typically includes a gap between the cab and the landing platform into the elevator shaft. This gap can extend around all sides of the entrance.

For passengers and cargo using an elevator there is a chance, when passing through the entrance, that an item may be dropped which happens to pass through the gap and become lost down the elevator shaft. Presuming such items survive the fall down to the bottom of the elevator shaft, they are not easily retrieved. This can represent no small inconvenience to the owner of the item when the item is a ring, key, credit card, mobile device, or other valuable item.

At other times, disrespectful individuals may intentionally dispose of items through the gap, for example, used chewing gum, bus transfers, tissue papers or similar detritus. Furthermore, cleaning staff may be in the habit of calling the elevator to the floor they are cleaning and sweeping debris through the gap.

Unfortunately for elevator mechanics, these lost items and discarded debris may collect at the bottom of the elevator shaft. Besides making the mechanic's job dirtier, such items and debris may impact the performance of machinery disposed at the bottom of the elevator shaft.

### SUMMARY OF THE INVENTION

The present disclosure describes a device for blocking the gap defined between an elevator cab and a landing platform.

According to a broad aspect of the present disclosure, a device for blocking a gap defined between an edge of a floor of an elevator cab and an edge of a landing platform when the cab is adjacent to the landing platform is provided. The device comprises a frame, fastening means for connecting the frame to the edge of the floor of the cab and a plurality of bristles connected to and extending from the frame. The plurality of bristles spans the length of the gap and having a length of approximately the width of the gap. When the elevator cab is adjacent the landing platform, the plurality of bristles extend into the gap substantially planar with and adjacent to the landing platform and the elevator cab floor.

According to another broad aspect of the present disclosure, an elevator cab is provided. The cab has walls and a floor cooperating to define an interior space and an exterior of the elevator cab. An entrance is defined in one wall for accessing the interior space. A plurality of bristles is connected to the one wall on the exterior of the elevator cab abutting an edge of the entrance. The plurality of bristles extends away from and substantially perpendicular to the exterior of the elevator cab. The plurality of bristles has a length such that, when the elevator cab is adjacent a landing platform, the plurality of bristles spans a gap between the entrance and the landing platform.

According to a further broad aspect of the present disclosure, a method for blocking a gap between an elevator cab and an adjacent landing platform is provided. The method comprises connecting a plurality of bristles to an exterior of the elevator cab adjacent an entrance of the elevator cab such that the plurality of bristles extend adjacent and substantially perpendicular to the exterior of the elevator cab. The method includes sizing the length of the plurality of bristles according to the width of the gap, and sizing the span of the plurality of bristles according to the length of the gap. When the elevator cab is adjacent the landing platform, the method blocks the gap between the elevator cab and the adjacent landing platform with the bristles such that items or debris are impeded from passing through the gap.

According to yet another broad aspect of the present disclosure, a device for blocking a gap defined between an elevator cab and a landing platform when the cab is adjacent to the landing platform is provided. The elevator cab has walls and a floor cooperating to define an interior and an exterior of the elevator cab and an entrance defined in one wall for accessing the interior of the elevator cab. The device comprises a frame, fastening means for connecting the frame to the exterior of the elevator cab abutting an edge of the one wall and the entrance and a plurality of bristles. The plurality of bristles is connected to and extends from the frame. The plurality of bristles spans the length of the gap and has a length of approximately the width of the gap. When the elevator cab is adjacent the landing platform, the plurality of bristles extend into the gap forming a substantially flush surface between the elevator cab the landing platform.

The features, functions, and advantages that have been discussed may be achieved independently in various embodiments of the present invention or may be combined in yet other embodiments, further details of which can be seen with reference to the following description and drawings but are not limited to embodiments described.

### BRIEF DESCRIPTION OF THE DRAWINGS

Having described embodiments of the present disclosure in general terms, reference will now be made to the accompanying drawings, which are not necessarily drawn to scale, and wherein like numbers refer to like elements throughout. Although specific terms are employed herein, such as up and down, vertical and horizontal, above and below, top and bottom or floor and ceiling, they are used in a generic, descriptive and relative sense only and not for purposes of limitation.

FIG. 1 illustrates a cross-sectional side view of an elevator shaft of a building.

FIG. 2 illustrates a partial isometric view of an entrance between an elevator cab and a landing platform with an embodiment of the present disclosure disposed there between.

FIG. 3 illustrates an enlarged cross section taken along the line A-A of FIG. 2.

FIG. 4 illustrates an isometric view of an embodiment of the present disclosure.

FIG. 5 illustrates a partial isometric view of a further embodiment of the present disclosure.

### DETAILED DESCRIPTION OF THE DRAWINGS

Embodiments of the present disclosure now will be described more fully hereinafter with reference to the accompanying drawings, in which some, but not all, embodiments are shown. Indeed, the present disclosure may be embodied in many different forms and should not be construed as limited to the embodiments set forth herein.

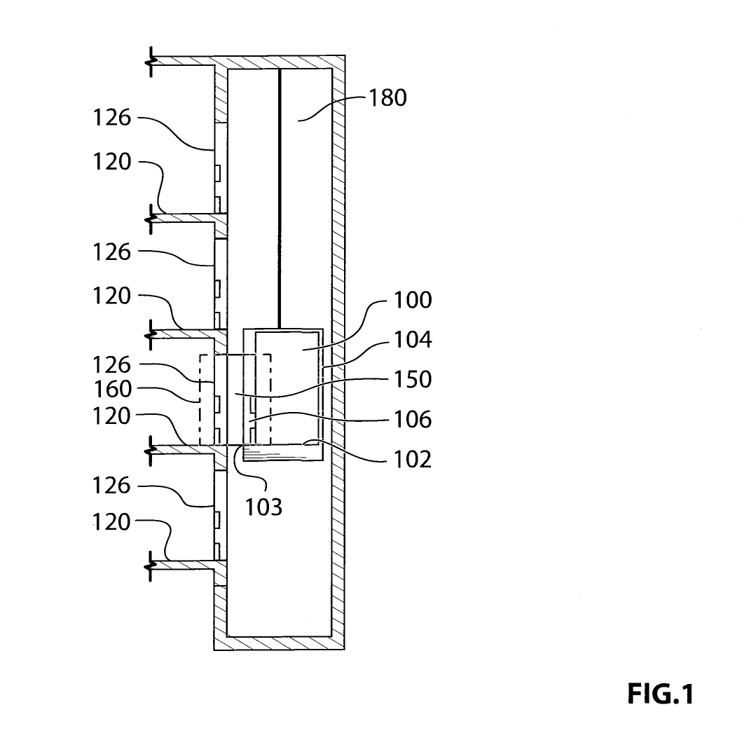

Referring to FIG. 1, elevators typically comprise an elevator cab 100 that travels in an elevator shaft 180 within a building to carry passengers, cargo and the like (not shown) from one floor to the next. A machine room or well is typically provided at the bottom of the elevator shaft. At each floor of the building adjacent the elevator shaft, a landing platform 120 is provided which, when the elevator cab 100 is adjacent the landing platform 120 and any doors 106 of the cab and doors 126 of the platform are opened, an entrance 160 is defined to permit passengers, cargo and the like to enter or exit the elevator cab.

The elevator cab 100 travels in a shaft 180. There is typically a gap 150 formed between the exterior of the elevator cab 100 and the landing platform 120 of each floor. In FIG. 1, the gap 150 is exaggerated for illustration purposes only. The gap 150 is large enough to permit the elevator cab 100 to pass by the landing platforms of each floor of the building. In some elevator configurations, the landing platforms 120 extend longitudinally partially into the elevator shaft 180. The gap 150 can be small enough that it does not significantly impact travel of passengers, cargo and the like through the entrance 160, when the elevator cab 100 is adjacent a landing platform 120 and any doors 106 of the elevator cab 100 or doors 126 of the landing platform 120 are opened.

The gap 150 can be defined along all sides of the entrance 160, that is, there is a portion of the gap 150 between the floor 102 of the elevator cab and the floor 122 of the landing platform, between the walls 104 of the elevator cab and the walls of the platform and between the roof of the elevator cab and the top of the platform entrance.

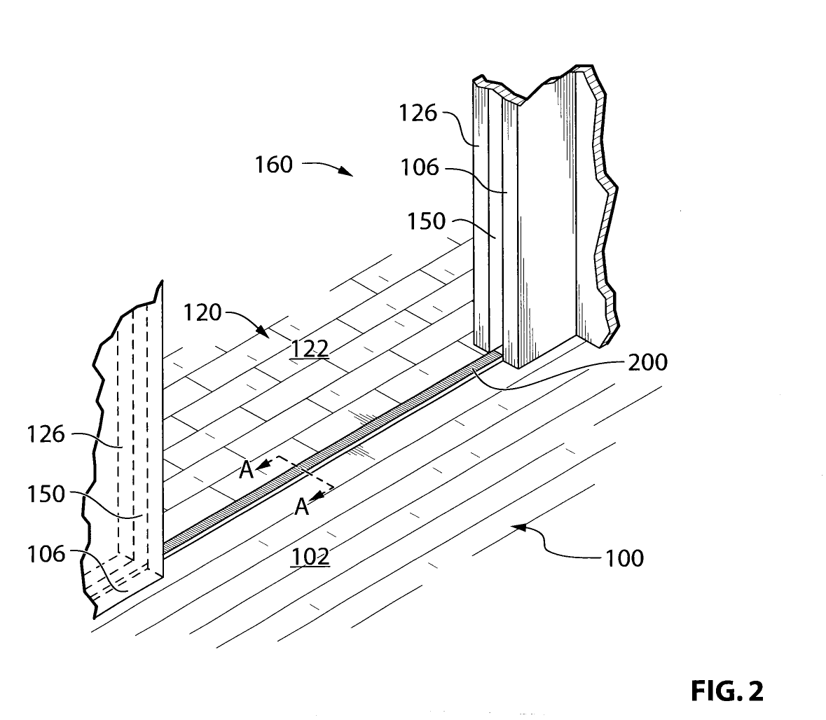

Referring to FIG. 2, the gap 150 is illustrated when the elevator cab 100 is adjacent a landing platform 120 and the doors 106 of the elevator cab 100 and the doors 126 of the landing platform are open forming entrance 160. The gap 150 extends between the floor 102 of the elevator cab and the floor 122 of the landing platform and between the doors 106 of the elevator cab and the doors 126 of the landing platform. A device 200 is disposed within the gap between the floors 102 and 122 forming a substantially flush surface from the floor 102 over the device 200 to the floor 122. A substantially flush surface permits easy retrieval of items dropped over the device 200 and provides a visual cue to an individual who may be considering disposing of detritus or debris though the gap 150.

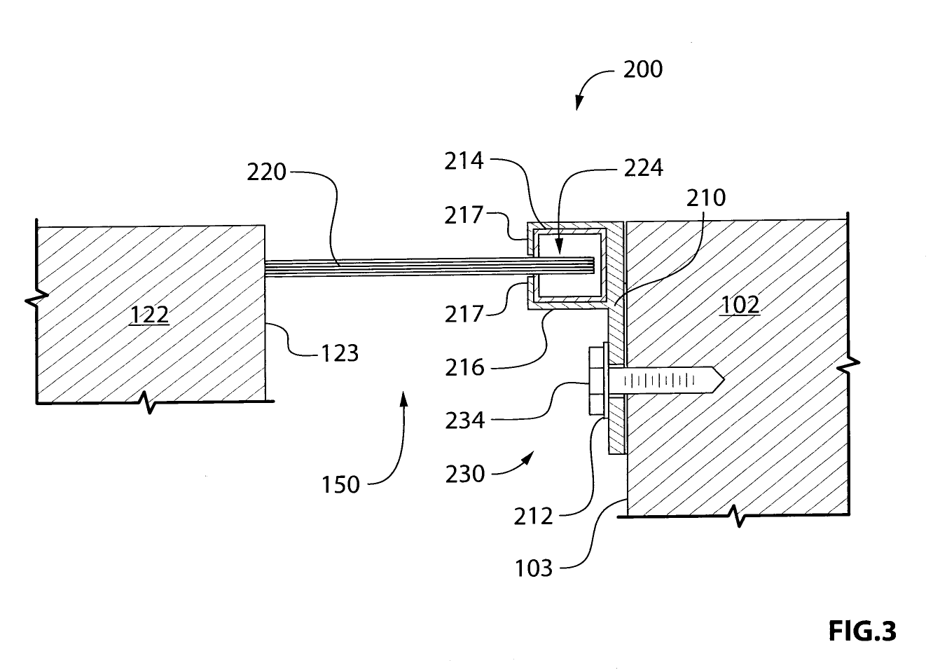

The device 200 is illustrated in FIGS. 2 and 3 as attached to the elevator cab 100. Although the device 200 illustrated in FIG. 2 is disposed in the gap 150 between the floors 102 and 122, the device 200 could also or additionally be disposed in other portions of the gap 150, for example, extending vertically between the edges of open doors 106 and 126.

Referring to FIG. 3, an enlarged cross section of an example embodiment of the device 200 is illustrated. The device 200 is illustrated at an edge 103 of the elevator cab floor 102 and substantially flush with the floor 102.

The device 200 is disposed within and spans the gap 150 to prevent objects from passing through the gap. The device 200 comprises a frame 210 retaining a bristle assembly 224 having a plurality of bristles 220 extending from the bristle assembly 224 and fastening means 230.

The frame 210 provides structure for the device 200, retaining the plurality of bristles 220 for extending into the gap 150, planar with the elevator cab floor 102, and permitting the fastening means 230 to secure the frame 210 to the elevator cab 100.

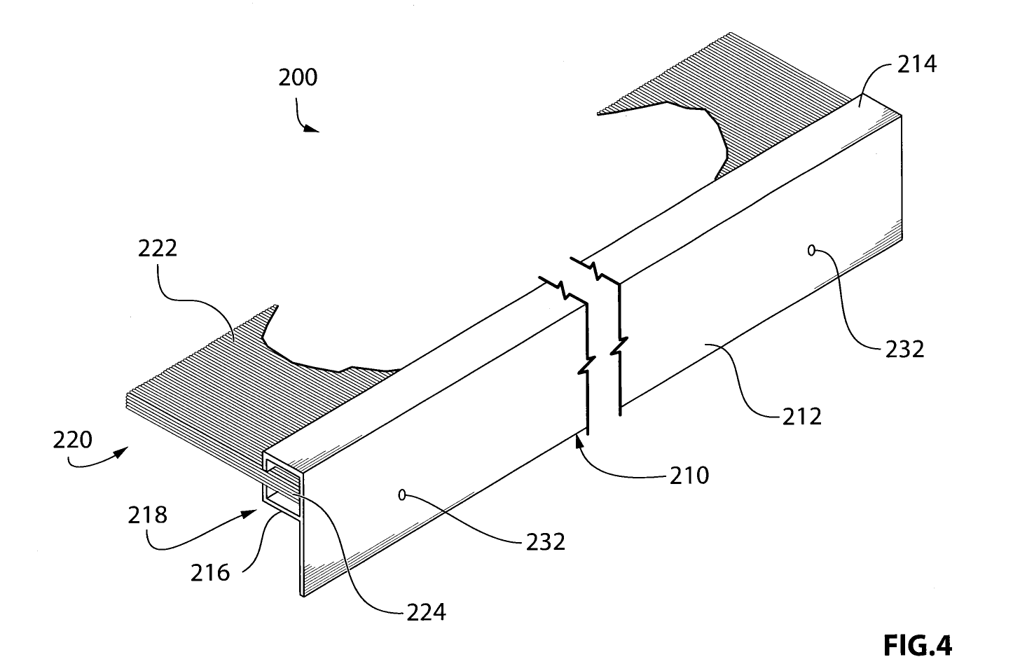

The frame 210 shown in FIGS. 3 and 4 is F-shaped in cross-section having a base 212, a top portion 214 extending from one end of the base 212 and a bottom portion 216 extending from the base 212 but displaced relative to the top portion 214. The top and bottom portions each have flanges 217 extending from a distal end of one of the top and bottom portions generally towards the other of the top and bottom portions. Together, the flanges 217, top portion 214 and bottom portion 216 form a receiving portion 218 (illustrated in FIG. 4) for receiving the bristle assembly 224 and holding the plurality of bristles 220. The frame 210 includes holes 232 which form one part of the mechanism for fastening the device 200 to an elevator cab 100.

The top portion 214 of the frame 210 shown in FIGS. 3 and 4 extends into the gap 150 when the device 200 is secured to the elevator cab 100 and the cab is adjacent to a landing platform 120. Thus the top portion 214 also prevents objects passing through part of the gap 150 as well as supporting the plurality of bristles 220. Furthermore, the top portion 214 can be aligned with the edge 103 of the floor 102 of the elevator cab 100 when the device 200 is secured to the elevator cab, so that the device 200 is substantially flush with the floor 102.

The frame 210 illustrated in FIGS. 3 and 4 has an F-shape however, other shapes of the frame are contemplated. It is within the teachings of the present disclosure to construct variously shaped structural frames that support extending the plurality of bristles 220 away from the elevator cab 100 and permit fastening the frame to the elevator cab.

The plurality of bristles impede or prevent items, detritus, debris or the like from passing through the gap 150 when the elevator cab 100 is adjacent to the landing platform 120. The plurality of bristles extends from the exterior of the elevator cab substantially perpendicular to the edge 103 of the elevator cab. The plurality of bristles 220 are held in place by the frame 210. The plurality of bristles may extend directly from the frame 210 or, as shown in FIGS. 3 and 4, extend from a bristle assembly 224 retained by the frame 210. As illustrated in FIGS. 2 and 3, the plurality of bristles 220 are planar to, and adjacent the elevator cab floor 102 such that, when the elevator cab 100 is adjacent a landing platform 120, an end of the bristles is adjacent the edge 123 of the landing platform floor 122.

As illustrated in FIG. 2, the plurality of bristles 220 span the length of the gap 150 from the doors 106, 126 on one side of the entrance 160 to the doors 106, 126 on the other side of the entrance 160. Bristles 222 in the plurality of bristles 220 shown in FIG. 3 have a length commensurate with the width of the gap 150 between the elevator cab floor 102 and the landing platform floor 122.

As the gap 150 may vary between the elevator cab and a landing platform for one floor versus another floor, the plurality of bristles can be flexible to accommodate smaller gaps without substantially overlapping the landing platform. Bristles can be sized to accommodate the largest gaps and flex to fit within smaller gaps. Flexible bristles permit variance in the width of the gap 150 between the edges of the elevator cab and the landing platform.

The flexibility and composition of the plurality of bristles also permits spanning and impeding gaps of irregular shapes. The flexibility of the plurality of bristles 220 also provides versatility to block a gap regardless of whether the elevator cab has moved down to the landing platform or up to the landing platform from a previous position in the elevator shaft 180.

The plurality of bristles has a density sufficient to prevent or impede items, detritus and debris from passing through the gap 150 when the device 200 is in place. In some embodiments, this is achieved with bristles 222 that are polypropylene fibre having a cross-sectional diameter of approximately 0.05 centimeters. In some embodiments, the plurality of bristles 220 has a density of 100 bristles per centimeter of length of the bristle assembly 224. In some embodiment, the plurality of bristles can be attached to the bristle assembly in spaced apart bunches containing approximately 40 bristles in a cross-sectional diameter of approximately 0.45 centimeters.

In some example embodiments, a bristle assembly 224 secures the plurality of bristles 220 to the frame 210. The bristle assembly shown in FIGS. 3 and 4 holds the plurality of bristles 220 at one end of the bristles, housing them within a structure complementary in shape to the receiving portion 218 of the frame 210. In one example embodiment, the bristle assembly 224 may be slideably inserted or removed from the frame 210. This permits removal and replacement of the bristle assembly and plurality of bristles. Other shapes and configurations of the bristle assembly and a complementary receiving portion of the frame are contemplated. This slideable installation can permit an elevator mechanic to size, cut and fit the frame 210 and the bristle assembly to any desired length.

Fastening means 230 are provided to secure the frame 210 to the elevator cab 100. Fastening means includes any mechanism for securing the frame 210 to the elevator cab 100. For example, the frame may be fastened to the elevator cab by adhesives, such as a glue and the like, nails, rivets, screws, bolts, staples and other such fasteners, welding or friction fitting the frame to the elevator cab or integrating the frame into the exterior body of the elevator cab.

As illustrated in FIGS. 3 and 4, the fastening means 230 comprises a fastener 234, such as a screw, and a hole 232 defined in the frame 210. The fastener 234 and hole 232 cooperate to secure the frame 210 to the elevator cab 100 at the edge 103 of the elevator cab floor 102. A number of holes 232 and fasteners 234 may be dispersed along the length of the frame 210 to adequately support the device 200.

In FIGS. 3 and 4, the fastening means 230 are disposed at an opposite edge of the frame 210 than the receiving portion 218. When the device 200 is installed on an elevator cab 100, this example embodiment permits the top of the frame 210 to be aligned substantially flush with the elevator cab floor 102 and hides the fastening means 230 from the view of elevator passengers.

According to an example method for blocking a gap 150 between an elevator cab 100 and an adjacent landing platform 120, a plurality of bristles 220 is connected to and extends away from the exterior of the elevator cab 100. In some embodiments, the plurality of bristles 220 extends substantially planar to the floor 102 of the elevator cab 100. The plurality of bristles 220 extends substantially perpendicular to the exterior of the elevator cab 100 so as to span the gap 150 when the elevator cab 100 is adjacent a landing platform 120. The length of the plurality of bristles is sized according to the width of the gap 150, or any portion thereof. The span of the plurality of bristles is sized according to the length of the gap 150, or any portion thereof.

In this configuration, when the elevator cab 100 is adjacent the landing platform 120, the gap 150 between the elevator cab 100 and the adjacent landing platform 120 is blocked with the plurality of bristles 220 such that items or debris are impeded from passing through the gap 150.

Connecting a plurality of bristles to the exterior of the elevator cab may include connecting a frame to an exterior wall of the elevator cab and connecting the bristles to the frame, or it may include connecting the plurality of bristles to a bristle assembly and connecting the bristle assembly to the exterior wall or to the frame. Connecting the bristle assembly to the frame may include longitudinally sliding the bristle assembly into the frame.

In some example embodiments, the length of the plurality of bristles is sized according to the largest of the widths of the gaps between the elevator cab and each landing platform in the elevator shaft 180.

In some example embodiments, the span of the plurality of bristles is sized according to the largest of the lengths of the gaps between the elevator cab and each landing platform in the elevator shaft 180.

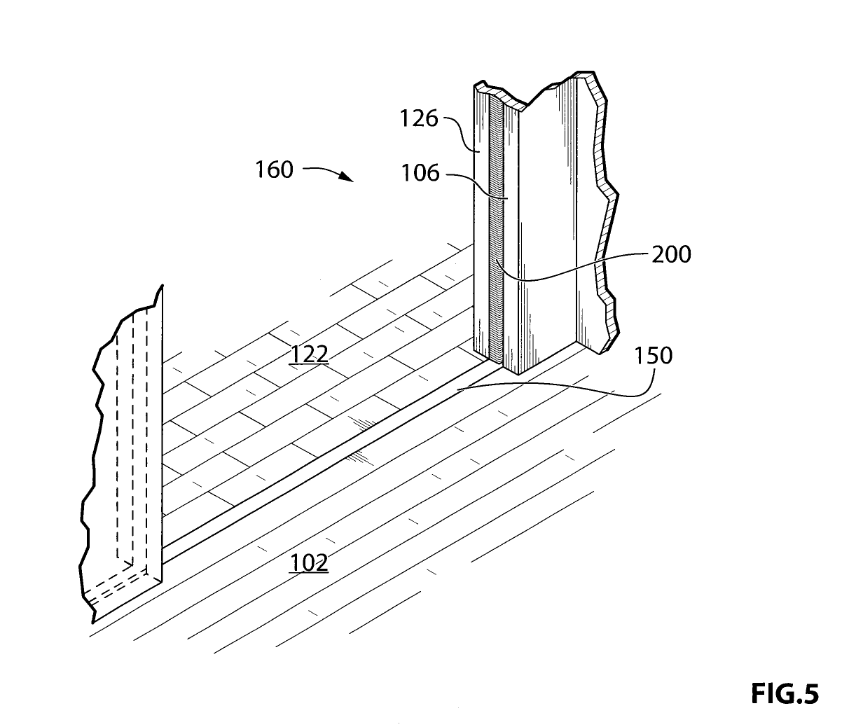

In an alternative embodiment illustrated in FIG. 5, the device 200 is connected to the exterior of the cab 100 at a vertical edge of the door 106 adjacent the entrance 160 so as to block a vertical portion of gap 150 defined between the edge of the door 106 and the edge of the door 126 when the elevator cab 100 is adjacent to the landing platform 120 and the doors 106 and 126 are open. Accordingly, devices 200 can be installed on either or both sides of the cab 100. In this configuration, the devices 200 could span the vertical gap from the floor 102 to the top of the entrance 160 or any portion thereof. The devices 200 could be installed flush to the ends doors 106 to minimize intrusion into the entrance 160. In this configuration, the plurality of bristles 220 could span from the edge of the door 106 to the edge of the door 126.

According to a further embodiment, a plurality of bristles can be integrated into the elevator cab 100 instead of disposing the plurality of bristles in a device to be secured to the elevator cab 100. For example, an existing elevator cab 100 can be modified, or a new elevator cab constructed, so that the exterior of the elevator cab or elevator cab doors receive a plurality of bristles. The plurality of bristles could have a span in accordance with an expected length of a typical gap and having bristle lengths in accordance with an expected width of a typical gap. In some elevator configurations, the width of a typical gap is between about 32 millimeters (1¼ inches) and 12 millimeters (½ inch). The plurality of bristles may be manufactured to have a larger than necessary length so they can be cut to size depending on the elevator shaft in which the elevator cab is disposed.

In a further embodiment, the plurality of bristles can be provided around any or all sides of an entrance to the elevator cab 100.

Although embodiments illustrated herein are generally described as blocking a gap between the floor of an elevator cab and a landing platform, it will be apparent to one of ordinary skill in the art that other embodiments of the present disclosure can be similarly used to block gaps defined between adjacent floors, roofs, doors or sidewalls. Specific embodiments of the present disclosure are described herein. Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments described and that modifications and other embodiments are intended to be included within the scope of the appended claims.

What is claimed is:

1. A device for blocking a gap defined between an edge of a floor of an elevator cab and an edge of a landing platform when the cab is adjacent to the landing platform, the device comprising:
a frame;
fastening means for connecting the frame to the edge of the floor of the cab; and
a plurality of bristles connected to and extending from the frame, the plurality of bristles spanning the length of the gap and having a length of approximately the width of the gap;
wherein, when the elevator cab is adjacent the landing platform, the plurality of bristles extend into the gap substantially planar with and adjacent to the landing platform and the elevator cab floor.

2. The device of claim 1 wherein the plurality of bristles have a length spanning the gap without substantially overlapping the landing platform when the elevator cab is adjacent the landing platform.

3. The device of claim 1 wherein the bristles have a flexibility such that the bristles flex to fit within gaps of different sizes at different landing platforms.

4. The device of claim 1 wherein the plurality of bristles comprise a sufficient number and density to impede items passing through the gap when the elevator cab is adjacent the landing platform.

5. The device of claim 1 further comprising a bristle assembly housing the plurality of bristles for securing the plurality of bristles to the frame.

6. The device of claim 5 wherein the bristle assembly slides longitudinally into the frame.

7. The device of claim 1 wherein the frame comprises a top portion extending partially into the gap flush with the edge of the floor of the elevator.

8. The device of claim 7 wherein the frame comprises a bottom portion extending partially into the gap cooperating with the top portion to secure the plurality of bristles to the frame.

9. The device of claim 8 further comprising a bristle assembly housing the plurality of bristles for securing the plurality of bristles between flanges of the top and bottom portions.

10. The device of claim 7 wherein the plurality of bristles are connected to the fastening means below the top portion and the fastening means are disposed beneath the plurality of bristles.

11. The device according to claim 1 wherein the fastening means comprises holes in the frame and bolts for securing the frame to the elevator cab through the holes.

12. The device according to claim 1 wherein the bristles comprise polypropylene fibre having a cross-sectional diameter of approximately 0.05 centimeters.

13. An elevator cab comprising:
walls and a floor cooperating to define an interior space and an exterior of the elevator cab;
an entrance defined in one wall for accessing the interior of the elevator cab; and
a plurality of bristles connected to the one wall on the exterior of the elevator cab abutting an edge of the entrance;
the plurality of bristles extends away from and substantially perpendicular to the exterior of the elevator cab; and
the plurality of bristles has a length such that, when the elevator cab is adjacent a landing platform, the plurality of bristles spans a gap between the entrance and the landing platform.

14. The elevator cab of claim 13 wherein the plurality of bristles have a length for, when the elevator cab is adjacent the landing platform, spanning the gap without substantially overlapping the landing platform.

15. The elevator cab of claim 13 wherein the bristles have a flexibility such that the bristles flex to fit within gaps of different sizes at different platforms.

16. The elevator cab of claim 13 wherein the plurality of bristles comprise a sufficient number and density to impede items passing through the gap when the elevator cab is adjacent the landing platform.

17. A method for blocking a gap between an elevator cab and an adjacent landing platform, the method comprising:
connecting a plurality of bristles to an exterior of the elevator cab adjacent an entrance of the elevator cab such that the plurality of bristles extend adjacent and substantially perpendicular to the exterior of the elevator cab;
sizing the length of the plurality of bristles according to the width of the gap;
sizing the span of the plurality of bristles according to the length of the gap;
when the elevator cab is adjacent the landing platform, blocking the gap between the elevator cab and the adjacent landing platform with the bristles such that items or debris are impeded from passing through the gap.

18. The method of claim 17 wherein the connecting a plurality of bristles to the exterior of the elevator cab comprises:
connecting a frame to a door of the elevator cab adjacent an entrance to the elevator cab; and
connecting the plurality of bristles to the frame such that the plurality of bristles extend adjacent the entrance and substantially perpendicular to the door of the elevator cab.

19. The method of claim 18 wherein the connecting the plurality of bristles to the frame includes connecting a bristle assembly having the plurality of bristles to the frame.

20. The method of claim 19 wherein the connecting the bristle assembly to the frame includes longitudinally sliding the bristle assembly into the frame.

21. A device for blocking a gap defined between an elevator cab and a landing platform when the cab is adjacent to the landing platform, the elevator cab having walls and a floor cooperating to define an interior and an exterior of the elevator cab and an entrance defined in one wall for accessing the interior of the elevator cab, the device comprising:
a frame;
fastening means for connecting the frame to the exterior of the elevator cab abutting an edge of the one wall and the entrance;
a plurality of bristles connected to and extending from the frame, the plurality of bristles spanning the length of the gap and having a length of approximately the width of the gap;
wherein, when the elevator cab is adjacent the landing platform, the plurality of bristles extend into the gap forming a substantially flush surface between the elevator cab the landing platform.

22. The device of claim 21 wherein the gap when the elevator cab is adjacent the landing platform is defined between a floor of the elevator cab and a floor of the landing platform.

23. The device of claim 21 wherein the gap when the elevator cab is adjacent the landing platform is defined between a door of the one wall and a door of the landing platform and the device is connected to the door of the one wall.

24. The device of claim 21 wherein the plurality of bristles have a length spanning the gap without substantially overlapping the landing platform when the elevator cab is adjacent the landing platform.

25. The device of claim 21 wherein the bristles have a flexibility such that the bristles flex to fit within gaps of different sizes at different landing platforms.

26. The device of claim 21 wherein the plurality of bristles comprise a sufficient number and density to impede items passing through the gap when the elevator cab is adjacent the landing platform.

27. The device of claim 21 further comprising a bristle assembly housing the plurality of bristles for securing the plurality of bristles to the frame.

28. The device of claim 27 wherein the bristle assembly slides longitudinally into the frame.

29. The device of claim 21 wherein the frame comprises a top portion extending partially into the gap flush with the edge of the floor of the elevator.

30. The device of claim 29 wherein the frame comprises a bottom portion extending partially into the gap cooperating with the top portion to secure the plurality of bristles to the frame.

31. The device of claim 30 further comprising a bristle assembly housing the plurality of bristles for securing the plurality of bristles between flanges of the top and bottom portions.

32. The device of claim 29 wherein the plurality of bristles are connected to the fastening means below the top portion and the fastening means are disposed beneath the plurality of bristles.

33. The device according to claim 21 wherein the fastening means comprises holes in the frame and bolts for securing the frame to the elevator cab through the holes.

34. The device according to claim 21 wherein the bristles comprise polypropylene fibre having a cross-sectional diameter of approximately 0.05 centimeters.
